(19) United States
(12) Patent Application Publication
(10) Pub. No.: US 2012/0270173 A1
(43) Pub. Date: Oct. 25, 2012

(54) ALIGNERS FOR INCREMENTALLY MOVING TEETH, AND METHODS AND APPARATUS OF MAKING AND USING SUCH ALIGNERS

(75) Inventors: Willis Pumphrey, Missouri City, TX (US); Jarrett Pumphrey, Houston, TX (US); Paul Dinh, Houston, TX (US)

(73) Assignee: CLEAR CORRECT HOLDINGS, INC.

(21) Appl. No.: 13/092,136

(22) Filed: Apr. 21, 2011

(51) Int. Cl. A61C 7/08

(52) U.S. Cl. 433/6; 433/24; 264/16

(57) ABSTRACT

Apparatus for repositioning teeth from an initial tooth arrangement to a final tooth arrangement, comprising a series of individual appliances comprising an introductory appliance that conforms to the initial tooth position, and remaining appliances of the series designed to incrementally reposition the teeth from an initial tooth arrangement, through a plurality of intermediate tooth arrangements (if there are any), and to a final tooth arrangement.

### BACKGROUND OF THE INVENTION

1. Field of the Invention

The present invention relates orthodontic apparatus and methods, and methods of making and using such orthodontic apparatus. In another aspect, the present invention relates to apparatus and methods for incrementally moving teeth, and to methods of making and using same. In another aspect, the present invention relates to apparatus and methods for repositioning teeth using a plurality of individual appliances placed successively on the patient's teeth and to incrementally reposition the teeth from an initial tooth arrangement, through a plurality of intermediate tooth arrangements, and to a final tooth arrangement, and to methods of making and using same. In even another aspect, the present invention relates to apparatus and methods for repositioning teeth using a plurality of individual appliances placed successively on the patient's teeth, with the plurality including an introductory appliance designed to maintain the initial position of the teeth, and the remaining appliances designed to incrementally reposition the teeth from an initial tooth arrangement, through a plurality of intermediate tooth arrangements (if any), and to a final tooth arrangement, and to methods of making and using same.

2. Brief Description of the Related Art

Traditionally, repositioning teeth for aesthetic or other reasons was generally accomplished by wearing what are commonly referred to as “braces”, which were typically metal orthodontic appliances affixed to the teeth and adjusted from time to time to reposition teeth. These metal-type braces generally include a small bracket that is glued to the front of each tooth and the molars are adjusted with a band that encircles the tooth.

These metal-type braces suffer from a number of disadvantages, including not being easily removable, limitations on the type of food that may be eaten, the required periodically tightening/adjustment by an orthodontist, and a perhaps most critical to many patients a certain unappealing look.

A very popular alternative to metal-type braces are progressive, removable aligners that may be used to gradually move teeth into their final positions, and while initially introduced as clear, recent trends all include colors and designs on some aligners.

The following patents, applications, and/or publications are merely a few of the many regarding apparatus and methods for repositioning teeth.

U.S. Pat. No. 5,975,893 issued Nov. 2, 1999, U.S. Pat. No. 6,217,325 issued Apr. 17, 2001, and U.S. Pat. No. 6,398,548 issued Jun. 4, 2002, all to Chishti et al., disclose a system for repositioning teeth that comprises a plurality of individual appliances. The appliances are configured to be placed successively on the patient's teeth and to incrementally reposition the teeth from an initial tooth arrangement, through a plurality of intermediate tooth arrangements, and to a final tooth arrangement. Each individual appliance will be configured so that its tooth-receiving cavity has a geometry corresponding to an intermediate or end tooth arrangement intended for that appliance. That is, when an appliance is first worn by the patient, certain of the teeth will be misaligned relative to an undeformed geometry of the appliance cavity. Systems according to Chisti et al. will include at least a first appliance having a geometry selected to reposition a patient's teeth from the initial tooth arrangement to a first intermediate arrangement where individual teeth will be incrementally repositioned. The system will further comprise at least one intermediate appliance having a geometry selective to progressively reposition teeth from the first intermediate arrangement to one or more successive intermediate arrangements. The system will still further comprise a final appliance having a geometry selected to progressively reposition teeth from the last intermediate arrangement to the desired final tooth arrangement. In some cases, it will be desirable to form the final appliance or several appliances to “over correct” the final tooth position.

U.S. Pat. No. 6,450,807, issued Sep. 17, 2002, to Chishti et al, discloses a system and method for positioning teeth. The methods and apparatus fit a set of upper and lower teeth in a masticatory system by generating a computer representation of the masticatory system and computing an occlusion based on interactions in the computer representation of the masticatory system.

U.S. Pat. No. 6,582,227 issued Jun. 24, 2003, to Phan et al., discloses methods and systems of repositioning teeth for use in orthodontic treatment, with particular applicability to removable elastic repositioning appliances. Such appliances may be challenged by traditional tooth movements that intrude the crown of the tooth or present tooth positions that reduce available points of purchase. These challenges may be overcome with a series of tooth movements in which a tooth is translated in a “root-first” position. The movements may take advantage of the inherent characteristics of elastic repositioning appliances in translating a tooth from a first position to a desired position along a gingival plane.

U.S. Pat. No. 7,578,674, issued Aug. 25, 2009, to Chishti et al., discloses methods for correcting tooth movements midcourse in treatment. The appliances are made using a dental mold representing a patient's dental configuration. In particular, thermoformable plastic positioning appliances which fit over the patient's teeth may be formed over a three-dimensional mold of the patient's dentition. Also disclosed are apparatus and methods which employ a manipulable or reconfigurable mold to model patient dentition and gingiva at each stage of treatment. The apparatus and methods are particularly useful for performing midcourse corrections during orthodontic procedures using a plurality of such appliances in sequence.

U.S. Patent Application Publication No. 20090286196, published Nov. 19, 2009, to Wen Huafeng et al., discloses a method for treating a subject's teeth with aligners. A target configuration for the subject's teeth is determined. Receiving features are produced on a dental base in response to the target configuration, the receiving features being configured to receive physical tooth models. The physical tooth models are assembled on the dental base to form a physical arch model. A dental aligner is produced using the physical arch model to move the subject's teeth to the target configuration.

U.S. Pat. No. 7,674,422 issued Mar. 9, 2010, to Kuo et al., discloses reinforced thin-shell molds. A method and a system for forming a polymeric resin mold for molding plastic items includes (a) using a rapid-prototyping process to create a polymeric resin shell having a configuration in the form of the mold; (b) introducing a reinforcing material into the shell; and (c) curing the shell. The system includes a rapid-prototyping apparatus that creates a plurality of the polymeric resin shells on a platform; a reinforcing material introduction apparatus that introduces a reinforcing material into each of the shells while the shells are on the platform to form a plurality of uncured molds on the platform; and a curing apparatus that cures the shells while they are on the platform.

U.S. Pat. No. 7,905,724, issued Mar. 15, 2011, to Kuo et al., discloses methods and systems for concurrent tooth repositioning and substance delivery, and includes devices, systems and methods for orthodontic treatment using elastic repositioning appliances while concurrently providing dental and periodontal therapies. Such therapies are traditionally provided with the use of a variety of accessories and devices that are applied when the repositioning appliance is removed from the patient's mouth. The present invention eliminates the need for such removal and additional devices by incorporating these therapies into the repositioning appliance.

Below is provided a listing of some patents relating to orthodontic apparatus and methods, which listing should not be considered comprehensive: U.S. Pat. Nos. 7,930,189; 7,922,490; 7,916,911; 7,914,283; 7,905,725; 7,905,408; 7,904,308; 7,904,307; 7,901,207; 7,883,334; 7,880,751; 7,878,805; 7,878,804; 7,878,801; 7,874,837; 7,871,269; 7,870,280; 7,865,259; 7,854,609; 7,844,429; 7,844,356; 7,841,858; 7,840,373; 7,837,904; 7,837,469; 7,831,322; 7,826,646; 7,824,180; 7,819,659; 7,802,987; 7,771,195; 7,766,658; 7,748,199; 7,746,339; 7,736,147; 7,711,447; 7,689,398; 7,658,610; 7,648,360; 7,641,828; 7,637,740; 7,611,058; 7,604,181; 7,600,999; 7,580,846; 7,578,673; 7,572,121; 7,553,157; 7,543,511; 7,481,647; 7,481,121; 7,476,100; 7,474,307; 7,472,789; 7,452,207; 7,448,514; 7,442,040; 7,435,084; 7,435,083; 7,433,810; 7,428,481; 7,384,266; 66 7,383,19; 8 7,377,778; 68 7,373,286; 7,361,020; 7,357,636 7,357,634 7,354,270; 7,335,024; 7,331,783; 7,326,051; 7,320,592; 7,309,230; 7,306,152; 7,293,988; 7,273,367; 7,261,533; 7,255,561; 7,247,021; 7,245,977; 7,241,142; 7,220,122; 7,201,576; 7,192,275; 7,156,661; 7,140,877; 7,134,874; 7,133,042; 7,125,248; 7,123,767; 7,121,825; 7,110,594; 7,108,508; 7,092,784; 7,077,647; 7,074,038; 7,063,533; 7,063,532; 7,059,850; 7,056,115; 7,040,896; 7,037,111; 7,037,108; 6,979,196; 6,976,627; 6,964,564; 6,948,936; 6,948,931; 6,947,038; 6,830,450; 6,814,574; 6,802,713; 6,790,035; 6,786,721; 6,783,604; 6,783,360; 6,767,208; 6,761,560; 6,729,876; 6,726,478; 6,722,880; 6,705,863; 6,705,861; 6,699,037; 6,688,886; 6,685,470; 6,685,469; 6,682,346; 6,665,570; 6,633,789; 6,629,840; 6,626,666; 6,621,491; 6,607,382; 6,602,070; 6,582,229; 6,572,372; 6,554,611; 6,524,101; 6,514,074; 6,499,997; 6,497,574; 6,488,499; 6,485,298; 6,471,511; 6,463,344; 6,457,972; 6,454,565; 6,409,504; 6,406,292; 6,394,801; 6,390,812; 6,386,878; 6,386,864; 6,371,761; 6,318,994; 6,309,215; 6,299,440; 6,227,851; 6,227,850; and 6,210,162

All of the patents, applications and publications cited in this specification, are herein incorporated by reference.

In obtaining a set of aligners, a very typical occurrence is that the patient will have a first office visit during which impressions are made of the initial tooth position. Most dental/orthodontic professionals send this initial tooth impression off to determine the final tooth position. Once this final tooth position is determined, all of the intermediate tooth positions will be determined. Finally, from these determined tooth positions, a set of aligners is manufactured that will reposition the teeth from the initial tooth position through all of the intermediate tooth positions to the final tooth position.

It will take a certain amount of time to study the initial tooth position and determine the final tooth position, a certain amount of time to then determine the intermediate positions. These positions are generally determined through digital modeling. Finally, there is a certain amount of time needed to manufacture the set of aligners. Thus, there is a certain lag between the time the patient has a dental/orthodontic office appointment and returns to receive the set of aligners, or at the very least one or more of the aligners in the series.

Once returning to the office for a second visit, it is at this time that the patient and/or the dental/orthodontic professional will be able to determine if the set of aligners is a good fit or not. In some instances, the first aligner in the set of aligners will not fit correctly. This poor fit may be due (1) an improper initial impression of the teeth resulting in an incorrect initial tooth position being obtained; (2) damage to the initial impression if a physical impression is utilized; (3) corruption in in the data files if a digital impression is utilized; (4) errors in the scanning process if a digital scan is utilized; (5) too much movement in the teeth between the time of the first office visit when the initial impression of the teeth was obtained and the second office visit when the aligners are being provided; (6) errors introduced during manufacturing; and/or (7) any of a number of other reasons.

Additionally, in some instances, patients have a hard time adjusting to the initial wearing of the first aligner. In some instances, the slight pressure on the teeth is irritating or annoying to the patient.

For treatment planning, certain treatment procedures are generally staged so as not to overwhelm the patient. For example, “engagers” might need to be affixed to the teeth to provide certain leverage to the aligner to move the tooth. In many instances, placing the engager on the tooth in conjunction with the first aligner will make the first aligner more difficult to put on/take off. Because patient compliance with wearing the aligner is paramount, and because the patient is just learning with this first appliance, any necessary engagers are generally postponed until the next office visit and affixed in conjunction with the 2^{nd} or 3^{rd} aligner. As another example, any interproximal reduction (“IPR”) is generally postponed until the 2^{nd} or 3^{rd} aligner for the same reason.

However, in spite of the above advancements, there still exists a need in the art for apparatus and methods for improved methods and apparatus for repositioning teeth.

There is another need in the art to determine if the initial impression of the teeth is adequately correct before making the set of aligners.

There is even another need in the art to reduce the amount of time between the first office visit when the initial impression is made, and the second office visit when the patient returns to begin treatment.

There is still another need in the art to assist patients in adjusting to the wearing of the aligners.

There is yet another need in the art to provide for methods and apparatus to allow certain procedures that might otherwise overwhelm a patient, such as engagers and IFRs, to be implemented earlier in the process, for example, with the first aligner.

These and other needs in the art will become apparent to those of skill in the art upon review of this specification, including its drawings and claims.

### SUMMARY OF THE INVENTION

It is an object of the present invention to provide for apparatus and methods for improved methods and apparatus for repositioning teeth.

It is another object of the present invention to provide for apparatus and methods to determine if the initial impression of the teeth is adequately correct before making the set of aligners.

It is even another object of the present invention to provide for apparatus and methods to reduce the amount of time between the first office visit when the initial impression is made, and the second office visit when the patient returns to begin treatment.

It is still another object of the present invention to provide for methods and apparatus to assist patients in adjusting to the wearing of the aligners.

It is yet another object of the present invention to provide for methods and apparatus to allow certain procedures that might otherwise overwhelm a patient, such as engagers and IFRs, to be implemented earlier in the process, for example, with the first aligner.

These and other objects of the present invention will become apparent to those of skill in the art upon review of this specification, including its drawings and claims.

According to one non-limiting embodiment of the present invention, there is provided a system for repositioning teeth from an initial tooth arrangement to a final tooth arrangement. The system may include a plurality of dental incremental position adjustment appliances. The system may include appliances may include an introductory appliance having a tooth receiving cavity geometry conforming to the initial tooth arrangement selected to maintain the teeth in the initial tooth position. The system may include one or more appliances having different tooth receiving cavity geometries, the geometries selected to progressively reposition the teeth from the initial tooth arrangement to the final tooth arrangement.

According to another non-limiting embodiment of the present invention, there is provided a method for repositioning teeth from an initial tooth arrangement to a final tooth arrangement. The method may include placing an introductory appliance in a patient's mouth, wherein the introductory appliance has a tooth receiving cavity geometry conforming to the initial tooth arrangement. The method may include successively placing one or more appliances having different tooth receiving cavity geometries, the geometries selected to progressively reposition the teeth from the initial tooth arrangement to the final tooth arrangement.

According to even another non-limiting embodiment of the present invention, there is provided an improved method for repositioning teeth using a set of appliances comprising polymeric shells having cavities shaped to receive and resiliently reposition teeth from an initial tooth arrangement to a final tooth arrangement. The method may include utilizing as an initial appliance of the set an introductory appliance having a tooth receiving cavity geometry conforming to the initial tooth arrangement.

According to still another non-limiting embodiment of the present invention, there is provided a method of making a set of dental incremental position appliances appliances comprising polymeric shells having cavities shaped to receive and resiliently reposition teeth from an initial tooth arrangement to a final tooth arrangement. The method may include forming as part of the set, an introductory appliance having a tooth receiving cavity geometry conforming to the initial tooth arrangement. The method may also include forming as part of the set, one or more appliances having different tooth receiving cavity geometries, the geometries selected to progressively reposition the teeth from the initial tooth arrangement to the final tooth arrangement.

According to yet another non-limiting embodiment of the present invention, there is provided a method for repositioning teeth from an initial tooth arrangement to a final tooth arrangement. The method may include placing an introductory appliance in a patient's mouth, wherein the introductory appliance has a tooth receiving cavity geometry conforming to the initial tooth arrangement. The method may include confirming the fit of the introductory appliance is adequate for treatment to proceed. The method may include making, only after confirming the fit, one or more appliances having different tooth receiving cavity geometries, the geometries selected to progressively reposition the teeth from the initial tooth arrangement to the final tooth arrangement. The method may include successively placing the one or more appliances having different tooth receiving cavity geometries, the geometries selected to progressively reposition the teeth from the initial tooth arrangement to the final tooth arrangement.

According to even still another non-limiting embodiment of the present invention, there is provided a method of making a set of dental incremental position appliances comprising polymeric shells having cavities shaped to receive and resiliently reposition teeth from an initial tooth arrangement to a final tooth arrangement. The method may include forming as part of the set, an introductory appliance having a tooth receiving cavity geometry conforming to the initial tooth arrangement. The method may include confirming the fit of the introductory appliance is adequate for treatment to proceed. The method may include forming as part of the set, only after confirming the fit, one or more appliances having different tooth receiving cavity geometries, the geometries selected to progressively reposition the teeth from the initial tooth arrangement to the final tooth arrangement.

According to even yet another non-limiting embodiment of the present invention, there is provided a method for repositioning teeth residing in a mouth from an initial tooth arrangement to a final tooth arrangement. The method may include placing an introductory appliance in the mouth, wherein the introductory appliance has a tooth receiving cavity geometry conforming to the initial tooth arrangement. The method may include confirming the fit of the introductory appliance is adequate for treatment to proceed. The method may include obtaining, only after confirming the fit, one or more appliances having different tooth receiving cavity geometries, the geometries selected to progressively reposition the teeth from the initial tooth arrangement to the final tooth arrangement. According to non-limiting sub-embodiments of this embodiment, the method may further comprise successively placing the one or more appliances having different tooth receiving cavity geometries in the mouth, the geometries selected to progressively reposition the teeth from the initial tooth arrangement to the final tooth arrangement.

According to still even another non-limiting embodiment of the present invention, there is provided a method of making a set of dental incremental position appliances comprising polymeric shells having cavities shaped to receive and resiliently reposition teeth from an initial tooth arrangement to a final tooth arrangement. The method may include forming as part of the set, an introductory appliance having a tooth receiving cavity geometry conforming to the initial tooth arrangement. The method may include receiving information regarding the fit of the introductory appliance. The method may include forming after receiving the information, one or more appliances of the set having different tooth receiving cavity geometries, the geometries selected to progressively reposition the teeth from the initial tooth arrangement to the final tooth arrangement.

According to still yet another non-limiting embodiment of the present invention, there is provided a method for repositioning teeth from an initial tooth arrangement to a final tooth arrangement. The method may include placing an introductory appliance in a patient's mouth, wherein the introductory appliance has a tooth receiving cavity geometry conforming to the initial tooth arrangement. The method may include gathering data regarding the fit of the introductory appliance relative to repositioning the teeth from the initial tooth arrangement to the final tooth arrangement. According to non-limiting sub-embodiments of this embodiment, the method may further comprise communicating the data to effect manufacture of one or more appliances having different tooth receiving cavity geometries, the geometries selected to progressively reposition the teeth from the initial tooth arrangement to the final tooth arrangement; and/or, successively placing the one or more appliances having different tooth receiving cavity geometries, the geometries selected to progressively reposition the teeth from the initial tooth arrangement to the final tooth arrangement. According to non-limiting sub-embodiments of this embodiment, this method may include receiving, only after gathering the data in step (B), one or more appliances having different tooth receiving cavity geometries, the geometries selected to progressively reposition the teeth from the initial tooth arrangement to the final tooth arrangement; and/or, successively placing the one or more appliances having different tooth receiving cavity geometries, the geometries selected to progressively reposition the teeth from the initial tooth arrangement to the final tooth arrangement. According to non-limiting sub-embodiments of this embodiment, the method may include obtaining, only after gathering the data, one or more appliances having different tooth receiving cavity geometries, the geometries selected to progressively reposition the teeth from the initial tooth arrangement to the final tooth arrangement; and/or successively placing the one or more appliances having different tooth receiving cavity geometries, the geometries selected to progressively reposition the teeth from the initial tooth arrangement to the final tooth arrangement.

According to even still another non-limiting embodiment of the present invention, there is provided a method of making a set of dental incremental position appliances comprising polymeric shells having cavities shaped to receive and resiliently reposition teeth from an initial tooth arrangement to a final tooth arrangement. The method may include forming as part of the set, an introductory appliance having a tooth receiving cavity geometry conforming to the initial tooth arrangement. The method may include receiving information regarding the fit of the introductory appliance. The method may include using the information in the fabricating of one or more appliances having different tooth receiving cavity geometries, the geometries selected to progressively reposition the teeth from the initial tooth arrangement to the final tooth arrangement.

According to even still another non-limiting embodiment of the present invention, there is provided a method of making a set of dental incremental position appliances comprising polymeric shells having cavities shaped to receive and resiliently reposition teeth from an initial tooth arrangement to a final tooth arrangement. The method may include forming as part of the set, an introductory appliance having a tooth receiving cavity geometry conforming to the initial tooth arrangement. The method may include confirming the fit of the introductory appliance is adequate for treatment to proceed. The method may include using the information in designing of one or more appliances having different tooth receiving cavity geometries, the geometries selected to progressively reposition the teeth from the initial tooth arrangement to the final tooth arrangement. The method may include fabricating the one or more appliances.

According to non-limiting sub-embodiments of any of the above embodiments, the tooth positions defined by the cavities in each successive appliance differ from those defined by the prior appliance by no more than 2 mm.

According to non-limiting sub-embodiments of any of the above embodiments, the successively placing step comprises placing at least three additional appliances prior to placing the final appliance.

According to non-limiting sub-embodiments of any of the above embodiments, the successively placing step comprises placing at least ten additional appliances.

According to non-limiting sub-embodiments of any of the above embodiments, the successively placing step comprises placing at least twenty-five additional appliances.

According to non-limiting sub-embodiments of any of the above embodiments, the appliances are successively replaced at an interval in the range from 2 days to 20 days.

According to non-limiting sub-embodiments of any of the above embodiments, the one or more appliances comprises a first appliance having a geometry selected to reposition the teeth from the initial tooth arrangement the final tooth arrangement.

According to non-limiting sub-embodiments of any of the above embodiments, the one or more appliances comprises a first appliance having a geometry selected to reposition the teeth from the initial tooth arrangement to a first intermediate arrangement, and a final appliance having a geometry selected to progressively reposition the teeth from the first intermediate arrangement to the final tooth arrangement.

According to non-limiting sub-embodiments of any of the above embodiments, the one or more appliances comprises a first appliance having a geometry selected to reposition the teeth from the initial tooth arrangement to a first intermediate arrangement, one or more intermediate appliances having geometries selected to progressively reposition the teeth from the first intermediate arrangement to successive intermediate arrangements, and a final appliance having a geometry selected to progressively reposition the teeth from the last intermediate arrangement to the final tooth arrangement, wherein the appliances comprise polymeric shells having cavities and wherein the cavities of successive shells have different geometries shaped to receive and resiliently reposition teeth from one arrangement to a successive arrangement.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a schematic representation of a prior art aligner system showing: a first aligner having a geometry selected to reposition a patient's teeth from the initial tooth arrangement to a first intermediate arrangement where individual teeth will be incrementally repositioned; one or more intermediate aligners having a geometry selective to progressively reposition teeth from the first intermediate arrangement to one or more successive intermediate arrangements; and a final aligner having a geometry selected to progressively reposition teeth from the last intermediate arrangement to the desired final tooth arrangement

FIG. 2 is a schematic of a non-limiting embodiment of the present invention showing: an introductory aligner configured so that its tooth-receiving cavity has a geometry corresponding to the initial tooth position such that when the introductory appliance is initially worn by the patient, none of the teeth should be misaligned relative to an undeformed geometry of the aligner cavity; first aligner having a geometry selected to reposition a patient's teeth from the initial tooth arrangement to a first intermediate arrangement where individual teeth will be incrementally repositioned; one or more intermediate aligners having a geometry selective to progressively reposition teeth from the first intermediate arrangement to one or more successive intermediate arrangements; and a final aligner having a geometry selected to progressively reposition teeth from the last intermediate arrangement to the desired final tooth arrangement.

FIG. 3 is a schematic representation of another non-limiting embodiment of the present invention showing: an introductory aligner as described above; and a combination first/final aligner to position a patient's teeth from the initial tooth arrangement to the final arrangement.

FIG. 4 is a schematic representation of another non-limiting embodiment of the present invention showing: an introductory aligner as described above; a first aligner as described above, and a final aligner as described above.

### DETAILED DESCRIPTION OF THE INVENTION

In some non-limiting embodiments of the practice of the present invention, a treatment plan may be determined for a patient progressing from the initial tooth arrangement, through intermediate tooth arrangements, to a final tooth arrangement. It should be understood, that sometimes, a treatment plan may be divided up into a number of smaller treatment plans, each having its own initial, intermediate and final tooth arrangements. It should also be understood that some treatment plans may have only an initial and final tooth arrangement.

Based on the determined treatment plan, a series of individual appliances may be configured as follows.

The introductory appliance of the series is one that conforms to the initial tooth position and is sequentially before the “first” appliance. This introductory appliance may be configured so that its tooth-receiving cavity has a geometry corresponding to the initial tooth position. In other words, when this introductory appliance is initially worn by the patient, none of the teeth should be misaligned relative to an undeformed geometry of the introductory appliance cavity. Should the teeth be somewhat misaligned relative to the undeformed geometry of the introductory appliance, the introductory appliance will correct the teeth back to the initial arrangement.

The remaining appliances of the series are designed to incrementally reposition the teeth from an initial tooth arrangement, through a plurality of intermediate tooth arrangements (if there are any), and to a final tooth arrangement. It is noted that all of the remaining appliances of the series, other than the introductory appliance, are all designed to create a tooth position that is different from the initial tooth position.

In the prior art, the appliance that moves the tooth geometry from the initial position to the first intermediate or next position of the treatment plan is generally known as the “first” appliance. Thus to avoid confusion with the prior art, in the practice of the present invention, the appliance that is positioned sequentially before this first appliance will be referred to as the “introductory” aligner.

Therefore, the sequential order of the series is as follows, the introductory appliance that conforms to the initial tooth position, and the remaining appliances of the series designed to incrementally reposition the teeth from an initial tooth arrangement, through a plurality of intermediate tooth arrangements (if there are any), and to a final tooth arrangement.

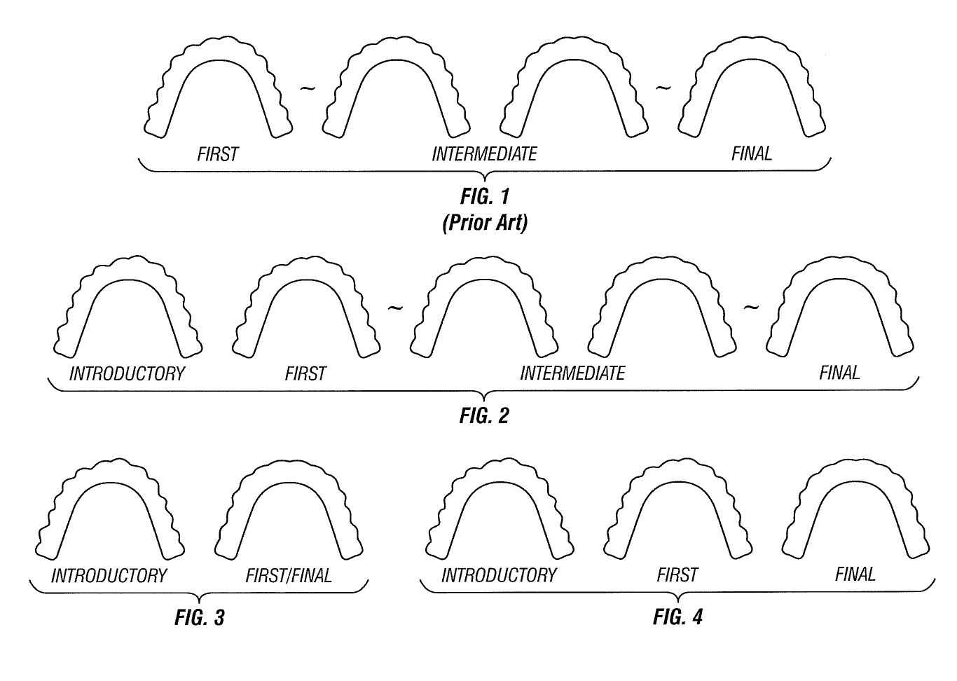

Referring additionally to the figures, FIG. 1 is a schematic representation of a prior art aligner system showing: a first aligner having a geometry selected to reposition a patient's teeth from the initial tooth arrangement to a first intermediate arrangement where individual teeth will be incrementally repositioned; one or more intermediate aligners having a geometry selective to progressively reposition teeth from the first intermediate arrangement to one or more successive intermediate arrangements; and a final aligner having a geometry selected to progressively reposition teeth from the last intermediate arrangement to the desired final tooth arrangement.

FIG. 2 is a schematic of a non-limiting embodiment of the present invention showing: an introductory aligner configured so that its tooth-receiving cavity has a geometry corresponding to the initial tooth position such that when the introductory appliance is initially worn by the patient, none of the teeth should be misaligned relative to an undeformed geometry of the aligner cavity; first aligner having a geometry selected to reposition a patient's teeth from the initial tooth arrangement to a first intermediate arrangement where individual teeth will be incrementally repositioned; one or more intermediate aligners having a geometry selective to progressively reposition teeth from the first intermediate arrangement to one or more successive intermediate arrangements; and a final aligner having a geometry selected to progressively reposition teeth from the last intermediate arrangement to the desired final tooth arrangement.

FIG. 3 is a schematic representation of another non-limiting embodiment of the present invention showing: an introductory aligner as described above; and a combination first/final aligner to position a patient's teeth from the initial tooth arrangement to the final arrangement.

FIG. 4 is a schematic representation of another non-limiting embodiment of the present invention showing: an introductory aligner as described above; a first aligner as described above, and a final aligner as described above.

Some embodiments of the system of the present invention may include an introductory aligner that conforms to the initial tooth position. In instances where this is a good fit, this introductory aligner confirms the fit of the aligner, confirms the integrity of the obtained initial tooth position, and should not move the teeth, but rather, will hold the teeth in the initial tooth position. It is important that the treatment plan start with the teeth in the initial tooth position to accurately implement the treatment plan, and this introductory aligner will help maintain the teeth in the initial tooth position until the patient installs that first aligner.

Some embodiments of the system of the present invention may include at least a first appliance having a geometry selected to reposition a patient's teeth from the initial tooth arrangement to a first intermediate arrangement where individual teeth may be incrementally repositioned. In some embodiments, this first aligner may move the patient's teeth from the initial to the final position, in which instance it may be considered a combination first/final aligner, in which case there are no intermediate positions between the initial and final positions.

After the introductory aligner, the remaining appliances of the series are configured to be placed successively on the patient's teeth and to incrementally reposition the teeth from the initial tooth arrangement, through a plurality of intermediate tooth arrangements (if any), and to a final tooth arrangement. Each individual remaining appliance may be configured so that its tooth-receiving cavity has a geometry corresponding to an intermediate or end tooth arrangement intended for that appliance. That is, when any of the remaining appliances is first worn by the patient, certain of the teeth may be misaligned relative to an undeformed geometry of the appliance cavity.

Thus, systems according to the present invention, may include at least an introductory appliance having a geometry corresponding to the initial tooth position and providing no repositioning of the teeth away from the initial position, and remaining appliances selected to reposition a patient's teeth from the initial tooth arrangement to a first intermediate arrangement where individual teeth may be incrementally repositioned. The system may further comprise at least one intermediate appliance having a geometry selected to progressively reposition teeth from the first intermediate arrangement to one or more successive intermediate arrangements. The system may still further comprise a final appliance having a geometry selected to progressively reposition teeth from the last intermediate arrangement to the desired final tooth arrangement. In some cases, it may be desirable to form the final appliance or several appliances to “over correct” the final tooth position.

In the practice of the present invention, the patient may have a first office visit during which impressions are made of the initial tooth position. While not impossible, it is not common that aligners are made in the office of the dental/orthodontic professional, but rather is made off-site and usually by a third party provider. From this initial tooth impression the introductory aligner is manufactured. It is anticipated that the patient will most likely have to return for the introductory aligner. However, it is also anticipated, that dental/orthodontic offices could be equipped to manufacture the introductory aligner as it will be made directly from the initial tooth position.

It is believed that this initial step of presenting a patient with the introductory appliance can be accomplished faster than presenting the patient with the traditional full or partial set of aligners. This is because, the introductory aligner can be quickly manufactured as it is made directly from the initial tooth position, without the need for determining the final tooth position, the intermediate tooth position, and without the need for manufacturing a partial or full set of aligners. The step of determining the final tooth position is somewhat time consuming, and while digital imaging software may be utilized, it still requires some amount of input to provide a feasible final position. The bottom line is that it does take some amount of time to determine the final position. The introductory aligner based directly on the initial tooth position and does not need to wait for the determination of the final tooth position. Of course, in those instances where the dental/orthodontic offices could be equipped to manufacture the introductory aligner, it may be possible to provide the aligner in the first visit, or certainly in an earlier second visit.

Once returning to the office for a second visit, it is at this time that the patient and/or the dental/orthodontic professional may be able to determine if the set of aligners is a good fit or not. That is, the dental/orthodontic professional will use professional skill, training and judgment to confirm that the fit of the introductory appliance is adequate for treatment to proceed. The dental/orthodontic professional will gather information that may be utilized in the design and/or manufacture of the remaining aligners, and may communicate such information to effect manufacture of the remaining aligners.

If the introductory aligner is an adequate fit, the patient is asked to wear the introductory aligner until the next (3^{rd}) office visit. The dental/orthodontic professional will communicate information regarding the fit to the third party manufacturer. The third party manufacturer will receive this information and may utilize this information in the design and/or manufacturer of the remaining aligners. Because the fit is adequate, resources can be expended in determining the final tooth arrangement, and any intermediate tooth arrangements, and manufacture can commence on at least the first aligner, and perhaps the intermediate and final aligners. One advantange of this that resources are not wasted based on using a poor first tooth position to determine the tooth positions and manufacture any aligners. Or at the very least, the information can be utilized to design a better set of remaining aligners. Upon return to the dental/orthodontic office for the third visit, the patient is presented with one or more of the remaining aligners that have been manufactured based on the information from the introductory aligner fit.

The wearing of the introductory aligner from the second to third office visits provides at least one of the following benefits.

First, it is believed that the introductory aligner can be presented to the patient in a quicker timeframe than presenting the traditional aligner set, and thus gets the patient into a treatment plan sooner. This introductory aligner can be manufactured from the initial tooth position without the need to determine the final tooth position and intermediate tooth position. Also, this introductory aligner is only one aligner as opposed to manufacturing a number of aligners. Again, as discussed above, it may be possible for the dental/orthodontic professional to make the introductory aligner in office during the visit. This would speed up confirmation of the fit, and speed up providing the patient with the introductory aligner. The remaining steps of determining the final and intermediate tooth positions, and manufacture of one or more of the aligners could commence with better confidence of the initial tooth position.

Second, this introductory aligner confirms that the impression taken of the initial tooth position was adequate, and confirms that the teeth have not moved substantially from the initial tooth position. It is after this confirmation that resources can be confidently expended in determining the final and intermediate tooth positions, first, final and intermediate aligners manufactured.

Third, this introductory aligner has helped to maintain the teeth in the initial tooth arrangement and should provide for a smoother transition into the first aligner. In some instances, this introductory aligner may be utilized to correct the teeth back to the initial tooth position. Maintaining the teeth in the initial tooth arrangement also means that the treatment plan from the initial tooth position to the first intermediate position is followed. While not believed to be common, it is possible that the teeth could wander into a position that is detrimental to the treatment plan, and might require a reconfiguring of the treatment plan. Having the first aligner installed with the teeth in the initial position provides integrity to the treatment plan and allows treatment to start from the known initial tooth position rather than form an unknown position.

Fourth, the very habit of wearing the introductory aligner has provided the patient with some amount of practice in wearing an aligner that should benefit the treatment process that relies upon patent compliance with wearing the aligners.

Fifth, because the patent has developed a certain comfort with wearing an aligner through use of the introductory aligner, certain procedures that in that past we postponed so as not to overwhelm the patient, non-limiting examples of which include engagers and IPR, can now be implemented in conjunction with the first aligner, thus both speeding up the treatment plan, and providing more flexibility in the treatment plan.

There is any number of reasons why the introductory appliance might not fit correctly. This poor fit may be due (1) an improper initial impression of the teeth resulting in an incorrect initial tooth position being obtained; (2) damage to the initial impression if a physical impression is utilized; (3) corruption in in the data files if a digital impression is utilized; (4) errors in the scanning process if a digital scan is utilized; (5) too much movement in the teeth between the time of the first office visit when the initial impression of the teeth was obtained and the second office visit when the aligners are being provided; (6) errors introduced during manufacturing; and/or (7) any of a number of other reasons.

If the introductory aligner is not an adequate fit because it appears that the teeth have moved the dental/orthodontic professional might decide to use the introductory aligner to correct the teeth back to the initial position and proceed with treatment as planned.

However, if the dental/orthodontic professional decides the introductory aligner is not an adequate fit because of problems with the introductory aligner, it may be necessary to go through the process again, and take another image of the initial tooth position, and obtain a new introductory aligner therefrom.

Determining that the introductory aligner is not a sufficient fit also results in saving resources that would have gone to making a treatment set of aligners that would most likely have been discarded. In some instances, this information may be utilized to design a better remaining aligners.

Methods and apparatus for determining the final tooth positions, and the intermediate tooth positions are well known to those of skill in the art, and any suitable ones may be utilized in the practice of the present invention. Methods and apparatus for manufacturing a set of aligners is likewise may be well known to those of skill in the art, and any suitable ones may be utilized in the practice of the present invention. While believed to be known to those of skill in the art, reference may be made to any of the numerous patents cited herein and incorporated by reference.

The appliances may be made of any suitable material. Very commonly, the appliances may comprise polymeric shells having cavities. In a series, the cavities of successive shells have different geometries shaped to receive and resiliently reposition teeth from one arrangement to a successive arrangement. A number of suitable materials and method of making/processing such materials are described in the prior art, including U.S. Pat. No. 7,641,828, which is herein incorporated by reference. Non-limiting examples of suitable materials include, but are not limited to transparent crystalline polymeric materials non-limiting examples of which but are not limited to, liquid crystalline polymeric materials, styrenics, and ion-containing polymers. As a non-limiting emobodiment, the introductory aligner may comprise polymeric shells having cavities shaped to receive the teeth and hold the teeth in or correct the teeth back to the initial position. As another non-limiting embodiment, the other appliances may comprise polymeric shells having cavities shaped to receive and resiliently reposition teeth away from the initial arrangement. While believed to be known to those of skill in the art, reference may be made to any of the numerous patents cited herein and incorporated by reference.

The aligner systems of the present invention may comprise at least any of the following number of aligners, or any range from/to or between any two of the following numbers of aligners: 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 75 and 100 aligners, counting the introductory aligner.

The successive use of a number of such aligners permits each aligner to be configured to move individual teeth in small increments, generally less than any of the following increments: 5 mm, 4 mm, 3 mm, 2.5 mm, 2 mm, 1.5 mm, 1 mm, 0.9 mm, 0.8 mm, 0.7 mm, 0.6 mm, 0.5 mm, 0.4 mm, 0.3 mm, 0.2 mm, 0.1 mm, 0.05 mm. These limits refer to the maximum linear translation of any point on a tooth as a result of using a single appliance. The movements provided by successive appliances, of course, will usually not be the same for any particular tooth. Thus, one point on a tooth may be moved by a particular distance as a result of the use of one appliance and thereafter moved by a different distance and/or in a different direction by a later appliance.

It should be understood that some embodiments of the aligner system of the present invention will comprise aligners having different tooth receiving cavity geometries based on successive tooth arrangements, the geometries selected to progressively reposition teeth from one arrangement to the next successive arrangement.

In the practice of the present invention, the appliances may be successively replaced at an interval in the range from/to or between any two of the following number of days: 0.25, 0.5, 1, 2, 3, 4, 5, 6, 7, 8, 9, 10, 11, 12, 13, 14, 15, 16, 17, 18, 19, 20, 25, 30, 35, 40, and 50 days.

It should be understood that the various physical components of the present invention may be well known to those of skill in the art. The patentability of the apparatus of the present invention does not reside in the patentablity of any single piece of equipment, but rather in the unique and nonobvious arrangement of the various equipment to form the overall apparatus or portion of the apparatus. Likewise, individual process steps may be generally known to those of skill in the art. The patentability of the process of the present invention does not reside in the patentablity of any single process step, but rather in the unique and nonobvious arrangement of the various process steps to form the overall process or a portion of the process.

The present disclosure is to be taken as illustrative rather than as limiting the scope or nature of the claims below. Numerous modifications and variations may become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A system for repositioning teeth from an initial tooth arrangement to a final tooth arrangement, said system comprising a plurality of dental incremental position adjustment appliances including:
(A) an introductory appliance having a tooth receiving cavity geometry conforming to the initial tooth arrangement selected to maintain the teeth in the initial tooth position; and,
(B) one or more appliances having different tooth receiving cavity geometries, the geometries selected to progressively reposition the teeth from the initial tooth arrangement to the final tooth arrangement.

2. The system of claim 1, wherein the one or more appliances comprises:
(C) a first appliance having a geometry selected to reposition the teeth from the initial tooth arrangement the final tooth arrangement.

3. The system of claim 1, wherein the one or more appliances comprises:
(C) a first appliance having a geometry selected to reposition the teeth from the initial tooth arrangement to a first intermediate arrangement; and,
(D) a final appliance having a geometry selected to progressively reposition the teeth from the first intermediate arrangement to the final tooth arrangement.

4. The system of claim 1, wherein the one or more appliances comprises:
(C) a first appliance having a geometry selected to reposition the teeth from the initial tooth arrangement to a first intermediate arrangement;
(D) one or more intermediate appliances having geometries selected to progressively reposition the teeth from the first intermediate arrangement to successive intermediate arrangements; and,
(E) a final appliance having a geometry selected to progressively reposition the teeth from the last intermediate arrangement to the final tooth arrangement, wherein the appliances comprise polymeric shells having cavities and wherein the cavities of successive shells have different geometries shaped to receive and resiliently reposition teeth from one arrangement to a successive arrangement.

5. A method for repositioning teeth residing in a mouth from an initial tooth arrangement to a final tooth arrangement using a set of appliances, the method comprising:
(A) placing an introductory appliance of the set in the mouth, wherein the introductory appliance has a tooth receiving cavity geometry conforming to the initial tooth arrangement; and,
(B) successively placing one or more appliances of the set having different tooth receiving cavity geometries in the mouth, the geometries selected to progressively reposition the teeth from the initial tooth arrangement to the final tooth arrangement.

6. The method of claim 5, where the tooth positions defined by the cavities in each successive appliance differ from those defined by the prior appliance by no more than 2 mm.

7. The method of claim 5, wherein the successively placing step comprises placing at least three appliances.

8. The method of claim 5, wherein the successively placing step comprises placing at least ten appliances.

9. The method of claim 5, wherein the successively placing step comprises placing at least twenty-five appliances.

10. The method of claim 5, wherein the appliances are successively replaced at an interval in the range from 2 days to 20 days.

11. The method of claim 5, wherein the one or more appliances comprises:
a first appliance having a geometry selected to reposition the teeth from the initial tooth arrangement the final tooth arrangement.

12. The method of claim 5, wherein the one or more appliances comprises:
a first appliance having a geometry selected to reposition the teeth from the initial tooth arrangement to a first intermediate arrangement; and,
a final appliance having a geometry selected to progressively reposition the teeth from the first intermediate arrangement to the final tooth arrangement.

13. The method of claim 5, wherein the one or more appliances comprises:
a first appliance having a geometry selected to reposition the teeth from the initial tooth arrangement to a first intermediate arrangement;
one or more intermediate appliances having geometries selected to progressively reposition the teeth from the first intermediate arrangement to successive intermediate arrangements; and,
a final appliance having a geometry selected to progressively reposition the teeth from the last intermediate arrangement to the final tooth arrangement, wherein the appliances comprise polymeric shells having cavities and wherein the cavities of successive shells have different geometries shaped to receive and resiliently reposition teeth from one arrangement to a successive arrangement.

14. An improved method for repositioning teeth using a set of appliances comprising polymeric shells having cavities shaped to receive and resiliently reposition teeth from an initial tooth arrangement to a final tooth arrangement, wherein the improvement comprises:
utilizing as an initial appliance of the set an introductory appliance having a tooth receiving cavity geometry conforming to the initial tooth arrangement.

15. A method of making a set of dental incremental position appliances comprising polymeric shells having cavities shaped to receive and resiliently reposition teeth from an initial tooth arrangement to a final tooth arrangement, the method comprising:
(A) forming as part of the set, an introductory appliance having a tooth receiving cavity geometry conforming to the initial tooth arrangement; and,
(B) forming as part of the set, one or more appliances having different tooth receiving cavity geometries, the geometries selected to progressively reposition the teeth from the initial tooth arrangement to the final tooth arrangement.

16. The method of claim 15, wherein the one or more appliances comprises:
a first appliance having a geometry selected to reposition the teeth from the initial tooth arrangement the final tooth arrangement.

17. The method of claim 15, wherein the one or more appliances comprises:
a first appliance having a geometry selected to reposition the teeth from the initial tooth arrangement to a first intermediate arrangement; and,
a final appliance having a geometry selected to progressively reposition the teeth from the first intermediate arrangement to the final tooth arrangement.

18. The method of claim 15, wherein the one or more appliances comprises:
a first appliance having a geometry selected to reposition the teeth from the initial tooth arrangement to a first intermediate arrangement;
one or more intermediate appliances having geometries selected to progressively reposition the teeth from the first intermediate arrangement to successive intermediate arrangements; and,
a final appliance having a geometry selected to progressively reposition the teeth from the last intermediate arrangement to the final tooth arrangement, wherein the appliances comprise polymeric shells having cavities and wherein the cavities of successive shells have different geometries shaped to receive and resiliently reposition teeth from one arrangement to a successive arrangement.

19. A method for repositioning teeth residing in a mouth from an initial tooth arrangement to a final tooth arrangement, the method comprising:
(A) placing an introductory appliance in the mouth, wherein the introductory appliance has a tooth receiving cavity geometry conforming to the initial tooth arrangement;
(B) confirming the fit of the introductory appliance is adequate for treatment to proceed; and,
(C) obtaining, only after confirming the fit in step (B), one or more appliances having different tooth receiving cavity geometries, the geometries selected to progressively reposition the teeth from the initial tooth arrangement to the final tooth arrangement.

20. The method of claim 19, further comprising,
(D) successively placing the one or more appliances having different tooth receiving cavity geometries in the mouth, the geometries selected to progressively reposition the teeth from the initial tooth arrangement to the final tooth arrangement.

21. A method as in claim 20, where the tooth positions defined by the cavities in each successive appliance differ from those defined by the prior appliance by no more than 2 mm.

22. A method as in claim 20, wherein the successively placing step comprises placing at least threetwo additional appliances prior to placing the final appliance.

23. A method as in claim 20, wherein the successively placing step comprises placing at least ten additional appliances.

24. A method as in claim 20, wherein the successively placing step comprises placing at least twenty-five additional appliances.

25. A method as in claim 20, wherein the appliances are successively replaced at an interval in the range from 2 days to 20 days.

26. The system of claim 20, wherein the one or more appliances comprises:
a first appliance having a geometry selected to reposition the teeth from the initial tooth arrangement the final tooth arrangement.

26. The system of claim 20, wherein the one or more appliances comprises:
a first appliance having a geometry selected to reposition the teeth from the initial tooth arrangement to a first intermediate arrangement; and,
a final appliance having a geometry selected to progressively reposition the teeth from the first intermediate arrangement to the final tooth arrangement.

27. A method of making a set of dental incremental position appliances comprising polymeric shells having cavities shaped to receive and resiliently reposition teeth from an initial tooth arrangement to a final tooth arrangement, the method comprising:
(A) forming as part of the set, an introductory appliance having a tooth receiving cavity geometry conforming to the initial tooth arrangement;
(B) receiving information regarding the fit of the introductory appliance;
(C) forming after receiving the information, one or more appliances of the set having different tooth receiving cavity geometries, the geometries selected to progressively reposition the teeth from the initial tooth arrangement to the final tooth arrangement.

28. The method of claim 27, wherein the one or more appliances comprises:
a first appliance having a geometry selected to reposition the teeth from the initial tooth arrangement the final tooth arrangement.

29. The method of claim 27, wherein the one or more appliances comprises:
a first appliance having a geometry selected to reposition the teeth from the initial tooth arrangement to a first intermediate arrangement; and,
a final appliance having a geometry selected to progressively reposition the teeth from the first intermediate arrangement to the final tooth arrangement.

30. The method of claim 27, wherein the one or more appliances comprises:
a first appliance having a geometry selected to reposition the teeth from the initial tooth arrangement to a first intermediate arrangement;
one or more intermediate appliances having geometries selected to progressively reposition the teeth from the first intermediate arrangement to successive intermediate arrangements; and
a final appliance having a geometry selected to progressively reposition the teeth from the last intermediate arrangement to the final tooth arrangement, wherein the appliances comprise polymeric shells having cavities and wherein the cavities of successive shells have different geometries shaped to receive and resiliently reposition teeth from one arrangement to a successive arrangement.

31. A method for repositioning teeth from an initial tooth arrangement to a final tooth arrangement, the method comprising:
(A) placing an introductory appliance in a patient's mouth, wherein the introductory appliance has a tooth receiving cavity geometry conforming to the initial tooth arrangement; and,
(B) gathering data regarding the fit of the introductory appliance relative to repositioning the teeth from the initial tooth arrangement to the final tooth arrangement.

32. The method of claim 31, further comprising
(C) communicating the data to effect manufacture of one or more appliances having different tooth receiving cavity geometries, the geometries selected to progressively reposition the teeth from the initial tooth arrangement to the final tooth arrangement; and,
(D) successively placing the one or more appliances having different tooth receiving cavity geometries, the geometries selected to progressively reposition the teeth from the initial tooth arrangement to the final tooth arrangement.

33. The method of claim 31, further comprising:
(C) receiving, only after gathering the data in step (B), one or more appliances having different tooth receiving cavity geometries, the geometries selected to progressively reposition the teeth from the initial tooth arrangement to the final tooth arrangement; and,
(D) successively placing the one or more appliances having different tooth receiving cavity geometries, the geometries selected to progressively reposition the teeth from the initial tooth arrangement to the final tooth arrangement.

34. The method of claim 31, further comprising:
(C) obtaining, only after gathering the data in step (B), one or more appliances having different tooth receiving cavity geometries, the geometries selected to progressively reposition the teeth from the initial tooth arrangement to the final tooth arrangement; and,
(D) successively placing the one or more appliances having different tooth receiving cavity geometries, the geometries selected to progressively reposition the teeth from the initial tooth arrangement to the final tooth arrangement.

35. A method of making a set of dental incremental position appliances comprising polymeric shells having cavities shaped to receive and resiliently reposition teeth from an initial tooth arrangement to a final tooth arrangement, the method comprising:
(A) forming as part of the set, an introductory appliance having a tooth receiving cavity geometry conforming to the initial tooth arrangement;
(B) receiving information regarding the fit of the introductory appliance;
(C) using the information in the fabricating of one or more appliances having different tooth receiving cavity geometries, the geometries selected to progressively reposition the teeth from the initial tooth arrangement to the final tooth arrangement.

36. A method of making a set of dental incremental position appliances comprising polymeric shells having cavities shaped to receive and resiliently reposition teeth from an initial tooth arrangement to a final tooth arrangement, the method comprising:
(A) forming as part of the set, an introductory appliance having a tooth receiving cavity geometry conforming to the initial tooth arrangement;
(B) confirming the fit of the introductory appliance is adequate for treatment to proceed;
(C) using the information in designing one or more appliances having different tooth receiving cavity geometries, the geometries selected to progressively reposition the teeth from the initial tooth arrangement to the final tooth arrangement; and,
(D) fabricating the one or more appliances.
